(19) United States
(12) Patent Application Publication
(10) Pub. No.: US 2024/0249312 A1
(43) Pub. Date: Jul. 25, 2024

(54) Artificial-Intelligence Based Campaign Configurator

(71) Applicant: 6Sense Insights, Inc., San Francisco, CA (US)

(72) Inventors: Deepak Sharma, Pune (IN); Ken Golonka, San Francisco, CA (US); Sonia Jaswal, Pune (IN); Viral Bajaria, Redwood City, CA (US)

(73) Assignee: 6Sense Insights, Inc., San Francisco, CA (US)

(21) Appl. No.: 18/420,554

(22) Filed: Jan. 23, 2024

Related U.S. Application Data
(60) Provisional application No. 63/481,270, filed on Jan. 24, 2023.

(51) Int. Cl. G06Q 30/0241

(52) U.S. Cl. CPC G06Q 30/0241

(57) ABSTRACT

Currently, significant technological obstacles prevent the automation of campaign configuration. Embodiments overcome these obstacles using an artificial intelligence (AI) model (e.g., comprising a k-nearest neighbor algorithm) that determines historical segments that match a target segment, based on one or more segment attributes. One or more thresholding criteria of a performance filter are applied to campaign configurations, associated with these matching historical segments, to determine one or more campaign configurations to be recommended. If one of these recommended campaign configurations is accepted, campaign settings for a new campaign may be auto-populated according to the accepted campaign configuration, such that a new campaign, with expected high performance, can be easily configured.

### CROSS-REFERENCE TO RELATED APPLICATIONS

This application claims priority to U.S. Provisional Patent App. No. 63/481,270, filed on Jan. 24, 2023, which is hereby incorporated herein by reference as if set forth in full.

### BACKGROUND

### Field of the Invention

The embodiments described herein are generally directed to artificial intelligence (AI), and, more particularly, to an AI-based campaign configurator.

### Description of the Related Art

Conventionally, when an agent for an organization wishes to target a segment of current or prospective customers, the agent must manually identify and configure an appropriate marketing campaign. Generally, the agent's objective is to determine a campaign that will lead to maximum reach and maximum budget spend, given the targeted segment. This may involve searching through historical data to identify past high-performing campaigns. Such a process is cumbersome and time-consuming. Currently, there is no suitable mechanism for automating such a process, and significant obstacles exist to automation, including how to identify past campaigns that will perform well for a current target segment.

### SUMMARY

Accordingly, systems, methods, and non-transitory computer-readable media are disclosed for an AI-based campaign configurator.

In an embodiment, a method comprises using at least one hardware processor to: receive a target segment; determine one or more segment attributes of the target segment; apply an artificial intelligence (AI) model to the one or more segment attributes to output one or more matching segments, wherein each of the one or more matching segments is associated with a historical campaign; determine one or more campaign configurations based on the one or more historical campaigns that are associated with the one or more matching segments; apply one or more thresholding criteria to the one or more campaign configurations to determine one or more recommended campaign configurations from the one or more campaign configurations; provide the one or more recommended campaign configurations to a user; when receiving an acceptance of one of the one or more recommended campaign configurations from the user, generate a user interface for defining a new campaign configuration such that one or more fields for campaign settings are auto-populated according to the accepted recommended campaign configuration; when receiving a declination of all of the one or more recommended campaign configurations from the user, generate the user interface for defining the new campaign configuration such that the one or more fields for campaign settings are not auto-populated according to any of the one or more recommended campaign configurations; provide the user interface to the user; and receive the new campaign configuration via the user interface.

The target segment may comprise a plurality of company accounts that are associated with a user account of the user. The one or more segment attributes may be a plurality of segment attributes.

The method may further comprise using the at least one hardware processor to initiate a new campaign to the target segment according to the new campaign configuration. Initiating the new campaign may comprise generating or selecting an advertisement that includes an embedded ad-pixel. Initiating the new campaign may comprise using the advertisement in at least one online channel.

The one or more segment attributes of the target segment may comprise one or more of: a size of the target segment; for each of one or more geographic regions, a proportion of the target segment that is located in the geographic region; a measure of a count of targetable Internet Protocol (IP) addresses associated with the target segment; a measure of spend per time interval for the target segment; a measure of reachability for the target segment; a minimum total spend for the target segment; a maximum total spend for the target segment; or a persona in the target segment.

The AI model may be trained using a training dataset that comprises, for each of a plurality of historical campaigns, the one or more segment attributes of a historical segment associated with that historical campaign. The training dataset may be generated by: acquiring impression data comprising a plurality of impressions for each of the plurality of historical campaigns; generating account-level impression data by mapping the plurality of impressions to company accounts; acquiring spend data comprising one or more spend parameters for each of the plurality of historical campaigns; generating aggregate campaign data by merging the account-level impression data and the spend data; and for each of the plurality of historical campaigns, calculating segment attributes of a historical segment, associated with the historical campaign, from the aggregate campaign data.

The AI model may comprise a k-nearest neighbor (KNN) algorithm that is trained to determine, from a plurality of historical segments, k historical segments that are nearest the target segment, based on a similarity between the target segment and the k historical segments in terms of the one or more segment attributes. Determining one or more matching segments may comprise calculating a similarity metric for each of the one or more segment attributes. The similarity metric, for each segment attribute i in the one or more segment attributes, may be calculated, between the target segment and each respective one of the k historical segments, as:

$${similarity}_{i} = \frac{minimum ( {target}_{i} , {historical}_{i} )}{maximum ( {target}_{i} , {historical}_{i} )}$$

wherein minimum(⋅) returns a minimum value, maximum(⋅) returns a maximum value, targetᵢ is a value of the segment attribute i for the target segment, and historicalᵢ is a value of the segment attribute i for the respective one of the k historical segments. Determining one or more matching segments may further comprise: for each of the one or more segment attributes, quantizing the similarity metric that was calculated for the segment attribute into either a first value or a second value, wherein the first value indicates that the similarity metric satisfies a respective threshold, and wherein the second value indicates that the similarity metric does not satisfy the respective threshold; and for each of the k historical segments, when all of the similarity metrics are the first value after quantization, determine that the historical segment matches the target segment, and when at least one of the similarity metrics is the second value after quantization, determine that the historical segment does not match the target segment.

Applying the AI model to the one or more segment attributes may comprise: applying the AI model to the one or more segment attributes, with persona-based targeting, to determine a first set of one or more matching segments; and applying the AI model to the one or more segment attributes, without persona-based targeting, to determine a second set of one or more matching segments, wherein the one or more matching segments that are output by the AI model are a plurality of matching segments that include the first set and the second set.

Applying one or more thresholding criteria to the one or more campaign configurations may comprise, for each of the one or more campaign configurations: determining one or more performance metrics of the campaign configuration; determining whether or not the campaign configuration satisfies the one or more thresholding criteria based on the one or more performance metrics; when determining that the campaign configuration satisfies the one or more thresholding criteria, including the campaign configuration in the one or more recommended campaign configurations; and when determining that the campaign configuration does not satisfy the one or more thresholding criteria, exclude the campaign configuration from the one or more recommended campaign configurations. The one more performance metrics for each of the one or more campaign configurations may comprise a reach, a pace, and a recommendation score that is calculated as a function of the reach and the pace. For each of the one or more campaign configurations, the reach and the pace may be calculated as:

$$reach = \frac{reached number of company accounts in segment}{total number of company accounts in segment}$$

$$pace = \frac{\frac{actual spend per time interval}{number of time intervals passed}}{maximum spend per time interval}$$

wherein reached number of company accounts in segment is a total number of company accounts in the matching segment that is associated with the historical campaign on which the campaign configuration is based, total number of company accounts in segment is a total number of company accounts in the matching segment that is associated with the historical campaign on which the campaign configuration is based, actual spend per time interval is a measure of an amount of money that was actually spent per a time interval on the matching segment that is associated with the historical campaign on which the campaign configuration is based, number of time intervals passed is a number of the time intervals spanned by the historical campaign on which the campaign configuration is based, and maximum spend per time interval is a maximum amount of money spent or spendable, on the matching segment that is associated with the historical campaign on which the campaign configuration is based, in a single one of the time intervals. Determining whether or not the campaign configuration satisfies the one or more thresholding criteria based on the one or more performance metrics may comprise: determining whether or not the reach satisfies a reach threshold; determining whether or not the pace satisfies a pace threshold; and when either the reach does not satisfy the reach threshold or the pace does not satisfy the pace threshold, determining that the campaign configuration does not satisfy the one or more thresholding criteria.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example process for AI-based campaign configuration, according to an embodiment;

FIG. 4 illustrates an example data pipeline for a database used for AI-based campaign configuration, according to an embodiment; and

FIG. 5 illustrates an example data pipeline for providing feedback to an AI model, according to an embodiment.

### DETAILED DESCRIPTION

In an embodiment, systems, methods, and non-transitory computer-readable media are disclosed for an Al-based campaign configurator. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Example Infrastructure

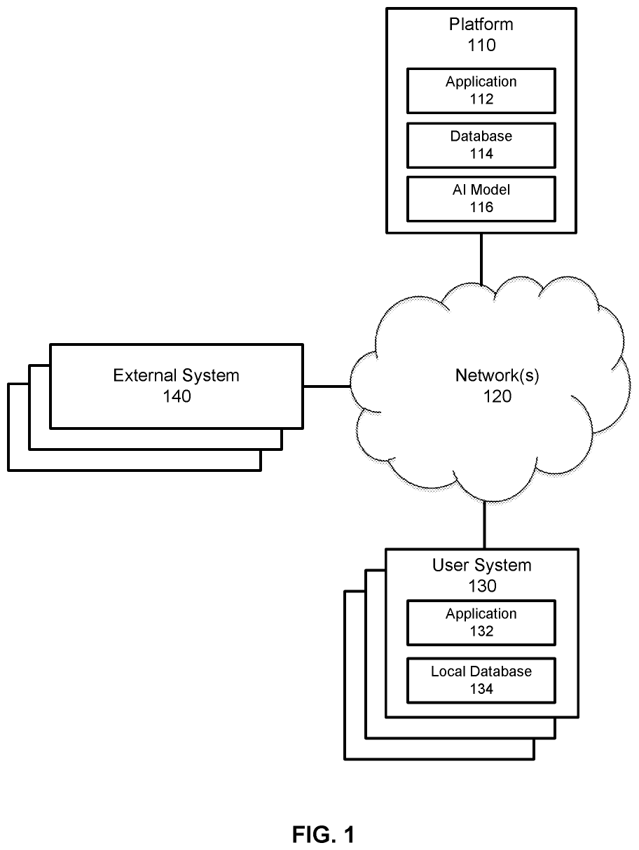

FIG. 1 illustrates an example infrastructure, in which one or more of the disclosed processes may be implemented, according to an embodiment. The infrastructure may comprise a platform 110 (e.g., one or more servers) which hosts and/or executes one or more of the various processes, methods, functions, and/or software modules described herein. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may also comprise or be communicatively connected to a server application 112 and/or one or more databases 114. Server application 112 may utilize one or more AI models 116 to perform one or more functions. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks 120. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, one database 114, and one AI model 116 are illustrated, it should be understood that the infrastructure may comprise any number of user systems, external systems, server applications, databases, and AI models.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal computer or professional workstation of a marketing representative or other agent of an organization. The organization may have an organizational account with platform 110, and the organizational account may be associated with one or a plurality of user accounts. Each agent of the organization may have one such user account, which enables the user to access functionality of platform 110, including one or more of the disclosed processes, via a respective user system 130 of the agent, according to roles and/or permissions associated with the respective user account. Each user system 130 may comprise or be communicatively connected to a client application 132 and/or one or more local databases 134.

External system(s) 140 may also comprise any types or types of computing devices capable of wired and/or wireless communication. However, it is generally contemplated that an external system 140 would be a server that supplies data to platform 110 and/or receives data from platform 110. For example, external system 140 may be the source of various data used by one or more of the disclosed processes, and/or may be the destination for various data output by one or more of the disclosed processes.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database 114) that are locally and/or remotely accessible to platform 110. It should be understood that platform 110 may also respond to other types of requests from user system(s) 130.

Platform 110 may comprise, be communicatively coupled with, or otherwise have access to database 114. For example, platform 110 may comprise one or more database servers which manage database 114. Server application 112 executing on platform 110 and/or client application 132 executing on user system 130 may submit data (e.g., user data, form data, etc.) to be stored in database 114, and/or request access to data stored in database 114. Any suitable database may be utilized as database 114, including without limitation MySQL™, Oracle™, IBM™, Microsoft SQL™, Access™, PostgreSQL™, MongoDB™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from user system(s) 130 and/or external system(s) 140, and provide responses in extensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130, may interact with a server application 112 executing on platform 110 to execute one or more or a portion of one or more of the various processes, methods, functions, and/or software modules described herein.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

### 2. Example Processing Device

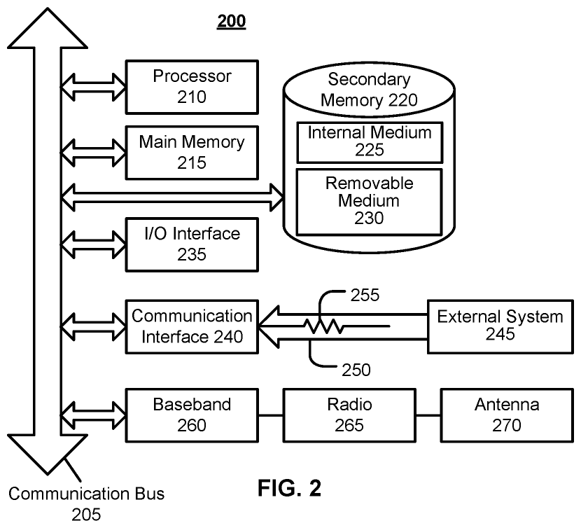

FIG. 2 is a block diagram illustrating an example wired or wireless system 200 that may be used in connection with various embodiments described herein. For example, system 200 may be used as or in conjunction with one or more of the processes, methods, or functions (e.g., to store and/or execute the software) described herein, and may represent components of platform 110, user system(s) 130, external system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet computer, or other mobile device).

System 200 may comprise a communication interface 240. Communication interface 240 allows software to be transferred between system 200 and external devices (e.g. printers), networks, or other information sources. For example, computer-executable code and/or data may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245 (e.g., which may correspond to an external system 140, an external computer-readable medium, and/or the like). In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enable system 200 to perform the various functions of the disclosed embodiments as described elsewhere herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

System 200 may comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform the various functions of the disclosed embodiments.

### 3. Process

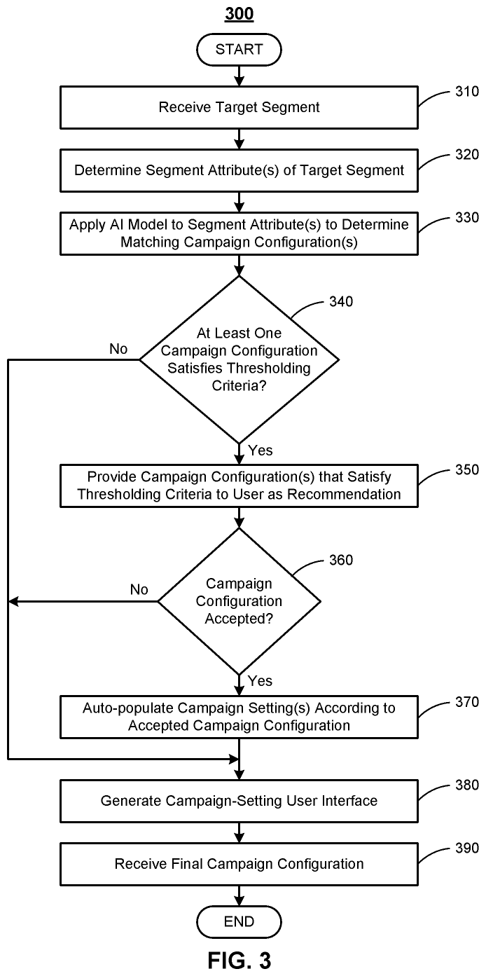

FIG. 3 illustrates an example process 300 for AI-based campaign configuration, according to an embodiment. Process 300 may be embodied in one or more software modules that are executed by one or more hardware processors (e.g., processor 210), for example, as a software application (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. Process 300 may be implemented as instructions represented in source code, object code, and/or machine code. These instructions may be executed directly by hardware processor(s) 210, or alternatively, may be executed by a virtual machine operating between the object code and hardware processor(s) 210.

Alternatively, process 300 may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

While process 300 is illustrated with a certain arrangement and ordering of subprocesses, process 300 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

Initially, in subprocess 310, a target segment is received. As used herein, the term “segment” may refer to a set of one or more, and generally a plurality of, company accounts. A “company account” refers to a current or prospective customer of an organization with an organizational account on platform 110. Thus, a user with a user account, that is associated with an organizational account on platform 110, may utilize platform 110 to manage a plurality of company accounts for the organization. A segment may comprise any subset, including potentially all, of the plurality of company accounts managed for the organization.

Subprocess 310 may comprise receiving a definition of the target segment via a graphical user interface of platform 110. For example, a user may define the target segment by selecting a set of one or more, and generally a plurality of, company accounts being managed by the user via platform 110, from a list of company accounts or a list of predefined groupings of company accounts, or in some other manner. Alternatively, the user may define the target segment by specifying a set of one or more criteria, in which case server application 112 may automatically identify and add any company accounts that satisfy the criteria to the target segment. Once the user has defined the target segment, the user may perform a user operation (e.g., select an input within the graphical user interface) to submit the target segment, such that the target segment is received in subprocess 310 (e.g., by server application 112).

In subprocess 320, one or more, and generally a plurality of, segment attributes are determined from the target segment. A segment attribute may be any property that describes at least a subset of the company account(s) within the segment. In an embodiment, the segment attribute(s) are quantitative properties that represent the collective nature of the company account(s) in the target segment. Ideally, the segment attribute(s) are good predictors of the performance of marketing campaigns. The segment attribute(s) may be calculated (e.g., using predefined equations, formulas, or other algorithms) from parameters associated with each of the company accounts in the segment. Exemplary segment attributes are described in detail elsewhere herein.

As used herein, it is generally contemplated that the term “marketing campaign” or simply “campaign” would refer to a digital advertising campaign. A digital advertising campaign refers to marketing through online channels, such as websites, email messages, streaming content, and/or the like. Advertisements in a digital advertising campaign may utilize any number of formats, including text, image, audio, video, and/or the like. However, it should be understood that disclosed embodiments can be applied to other types of campaigns, including other types of online campaigns, as well as offline advertising campaigns.

In an embodiment, a campaign is defined by a campaign configuration, which comprises or consists of one or more campaign settings. Thus, the terms “campaign,” “campaign configuration,” and “campaign settings” may be used interchangeably herein. For example, it should be understood that when a campaign is being recommended, it is actually one or more campaign settings that are being recommended. These campaign setting(s) may represent all of the configurable campaign settings or only a portion of the configurable campaign settings. In either case, these campaign setting(s) may also be referred to as a “campaign configuration.” A campaign configuration may comprise or consist of any subset of configurable campaign settings, and may, but does not need to, comprise all of the configurable campaign settings. Examples of configurable campaign settings include, without limitation, a total amount of money (i.e., total budget) available to be spent on the campaign, a maximum spend per time interval (e.g., daily budget), a maximum bid for the cost per thousand impressions (CPM) for the campaign, whether or not to include personas in the target segment, the channel(s) to be targeted, and/or the like.

In subprocess 330, an AI model 116 is applied to the segment attribute(s) determined in subprocess 320. In particular, the segment attribute(s) of the target segment are input as features (e.g., in a feature vector) to AI model 116, which determines one or more historical segments that match the target segment (e.g., by having similar segment attribute(s) to the target segment). Subprocess 330 may further comprise determining the campaign configuration(s) of the historical campaign(s) that are associated with the matching historical segment(s). The output of subprocess 330 may comprise one or more candidates for campaign configurations to be recommended. Each campaign configuration may comprise the value of each of one or more campaign settings that collectively define at least a portion of a campaign. The value of a campaign setting in each campaign configuration, output by subprocess 330, may be expressed as a discrete value or as a range of values.

Subprocess 330 (e.g., AI model 116) may output a confidence score in association with each campaign configuration that is output. The confidence score may represent a degree of match (e.g., according to a similarity metric) between a historical segment, with which a historical campaign having the campaign configuration is associated, and the target segment. It should be understood that campaign configurations that were previously used for segments that are more similar to the given target segment, in terms of the segment attribute(s), will have a higher degree of match than campaign configurations that were previously used for segments that are less similar to the given target segment in terms of the segment attribute(s). In an embodiment, only a fixed number of the campaign configurations that are output by AI model 116 are output by subprocess 330. For example, the top N (e.g., N=1, N=3, N=5, etc.) campaign configurations, in terms of confidence score, may be output by subprocess 330, whereas all other campaign configurations are excluded from further processing. In an alternative embodiment, only campaign configurations with a confidence score above a predefined threshold may be output by subprocess 330, whereas all other campaign configurations are excluded from further processing.

AI model 116 may be specific to a particular organization. For example, each organizational account may have an associated AI model 116, and AI models 116 for different organizational accounts may differ from each other. In other words, a first AI model 116 may be applied in each iteration of subprocess 330 for a first organizational account, and a second AI model 116, which is different from first AI model 116, may be applied in each iteration of subprocess 330 for a second organizational account, which is different from the first organizational account. In this case, each AI model 116 may be trained only on historical data for the associated organizational account. Alternatively, each AI model 116 may be trained on historical data for a plurality of organizational accounts, and then fine-tuned on historical data for the associated organizational account. As another alternative, each organizational account may utilize the same AI model 116. In other words, the same AI model 116 may be utilized across the entire platform 110.

In subprocess 340, one or more thresholding criteria may be applied to the campaign configuration(s) output by subprocess 330. In an embodiment, the thresholding criteria are designed to avoid recommending campaign configurations that, despite being output by AI model 116 with the highest confidence scores, are not likely to perform well for the target segment. In particular, a relatively high confidence score only indicates that the segment associated with the campaign configuration is relatively closer (e.g., in terms of a similarity metric) to the target segment than segments associated with other campaign configurations. The confidence score does not indicate how well the campaign configuration performed historically. Accordingly, the thresholding criteria may consider historical performance metrics of the campaign configuration(s) output by subprocess 330. Exemplary thresholding criteria will be described in detail elsewhere herein. When at least one campaign configuration, output by subprocess 330, satisfies the thresholding criteria (i.e., “Yes” in subprocess 340), process 300 proceeds to subprocess 350. Otherwise, when no campaign configurations, output by subprocess 330, satisfy the thresholding criteria (i.e., “No” in subprocess 340), process 300 proceeds to subprocess 380. It should be understood that it is possible that no campaign configurations will satisfy the thresholding criteria in subprocess 340, in which case, no campaign configurations may provided as a recommendation.

In subprocess 350, the campaign configuration(s) that satisfy the thresholding criteria are provided to the user as a recommendation. It should be understood that campaign configuration(s) that do not satisfy the thresholding criteria in subprocess 340 may be excluded, such that they are never recommended or otherwise provided to the user. In an embodiment, the campaign configuration(s) that satisfy the thresholding criteria are displayed in the graphical user interface as recommended campaign configuration(s). For example, the recommended campaign configuration(s) may be displayed as a list of visual representations. Each visual representation may represent a single one of the recommended campaign configuration(s), and may comprise information about the respective campaign. This information may comprise the value of each of one or more segment attributes of the segment associated with the campaign, a description of one or more of the campaign settings that define the campaign configuration, an expected performance (e.g., in terms of one or more performance metrics) of the campaign, and/or the like. Each visual representation of a recommended campaign configuration may be selectable and/or may comprise or be associated with one or more inputs for accepting and/or rejecting the recommend campaign configuration.

In subprocess 360, it is determined whether or not one of the recommended campaign configuration(s), provided in subprocess 350, is accepted. In particular, the user may perform an operation within the graphical user interface to accept one of the recommended campaign configuration(s). For example, the user may select the visual representation of one of the recommended campaign configuration(s) or another input for accepting one of the recommended campaign configuration(s). At a high level, the user is provided with the option to either start configuring a new campaign from the campaign configuration of a high-performing historical campaign that targeted a similar segment as the target segment (e.g., imitate or mimic the historical campaign with an expectation that the new campaign will achieve similar performance), or start configuring the new campaign from scratch. When the user accepts one of the recommended campaign configuration(s) (i.e., “Yes” in subprocess 360), process 300 proceeds to subprocess 370. Otherwise, when the user implicitly or explicitly rejects all of the recommended campaign configuration(s) (i.e., “No” in subprocess 360), process 300 proceeds to subprocess 380.

In subprocess 370, one or more campaign settings are auto-populated according to the campaign configuration that was accepted in subprocess 360. In particular, the campaign configuration comprises the value of each of one or more configurable campaign settings that define a campaign configuration. The value of each of these campaign setting(s), in the accepted campaign configuration, may be automatically copied to the corresponding campaign setting(s), in a new campaign configuration.

In subprocess 380, a campaign-setting user interface is generated. The campaign-setting user interface may comprise one or more fields (e.g., textboxes, drop-down menus, radio buttons, checkboxes, etc.) for defining the individual campaign setting(s) that define the campaign configuration for a new campaign. In the event that one or more campaign settings have been auto-populated in subprocess 370, the field(s) for these campaign setting(s) will be pre-populated with the values in the accepted campaign configuration. On the other hand, in the event that no campaign configuration was recommended (e.g., because no campaign configuration was output by Al model 116 or no campaign configuration satisfied the thresholding criteria) or no campaign configuration was accepted (e.g., “No” in subprocess 360), the fields will be either blank or pre-populated with default values. In some cases, an accepted campaign configuration may define fewer than all of the campaign settings. In such a case, some fields may be pre-populated with the values of corresponding campaign settings in the accepted campaign configuration, while the remaining fields may be either blank or pre-populated with default values.

In subprocess 390, the final campaign configuration may be received. In particular, the user may review, potentially modify, and submit the values of the fields in the campaign-setting user interface. It should be understood that the user may modify any of the fields in the campaign-setting user interface, prior to submission, including those fields which were pre-populated according to an accepted campaign configuration. In response to subprocess 390, a new campaign with the final campaign configuration may be saved (e.g., in database 114) in association with the target segment received in subprocess 310.

In addition, in response to or otherwise after subprocess 390, the new campaign may be automatically (i.e., without user involvement), semi-automatically (e.g., with user confirmation or approval), or manually (e.g., in response to a user operation) initiated or executed with respect to the target segment. Execution of a campaign may comprise generating or selecting advertisement(s) (e.g., images and/or videos, brochures or mailers, etc.), placing the advertisement(s) in channels (e.g., within banner ads, at the start of or in the middle of videos, etc., on one or more websites) that are trafficked by company accounts in the target segment, sending the advertisement(s) to the company accounts in the target segment (e.g., in email messages to email addresses of contacts associated with the company accounts, in the mail to mailing addresses associated with contacts associated with the company accounts or associated with the company accounts themselves, in Short Message Service (SMS) or Multimedia Messaging Service (MMS) messages or other text or multimedia messages to telephone numbers associated with contacts associated with the company accounts, etc.), submitting the advertisement(s) for search engine marketing (SEM) (e.g., purchasing search terms from a search engine for sponsored placement of the advertisement(s)), and/or the like. It should be understood that an advertisement may comprise any type and format of marketing creative, and that the type and format of marketing creative may differ based on the channel to which the advertisement is directed. Advertisements (e.g., images, videos, animations, etc.) directed to or used in online channels (e.g., websites, sponsored search terms, email messaging, text messaging, etc.) may incorporate embedded ad-pixels for impression tracking, as discussed elsewhere herein.

### 4. Example Data Pipeline

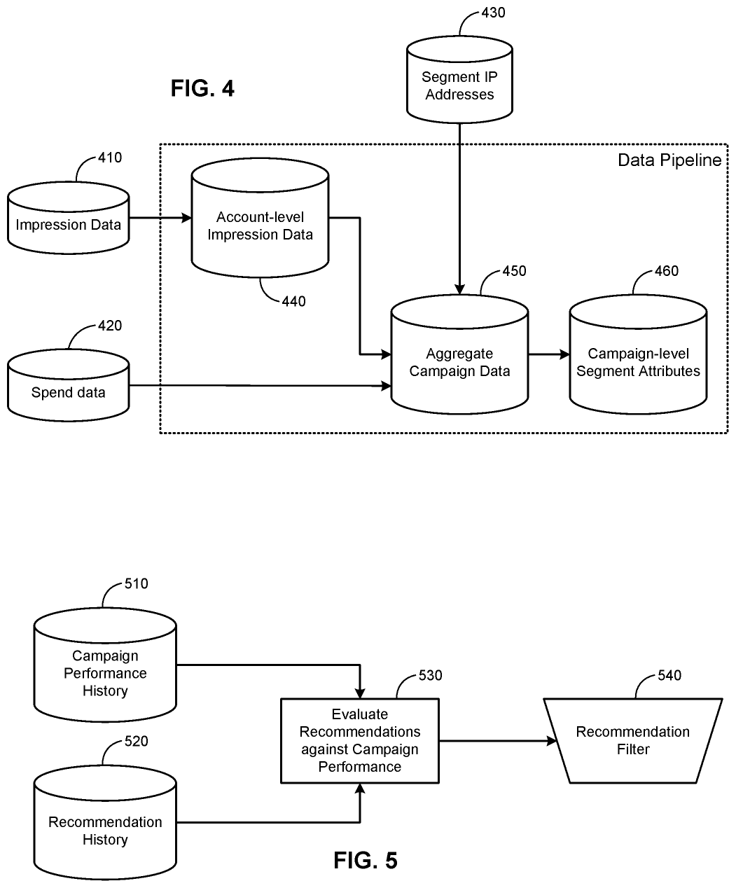

FIG. 4 illustrates an example data pipeline for a database used for AI-based campaign configuration, according to an embodiment. The data pipeline may be supplied by one or a plurality of data sources, including impression data 410, spend data 420, and segment Internet Protocol (IP) addresses 430. These data source(s) may include a user system 130 (e.g., uploading the data), an external system 140 (e.g., which pushes the data to platform 110 through an application programming interface of server application 112, or from which the data is pulled by platform 110 through an application programming interface of external system 140), database 114 (e.g., retrieving the data via one or more indices), and/or the like. Within the data pipeline, the data from the data source(s) are transformed into account-level impression data 440, then into aggregate campaign data 450, and finally into campaigns and segment attributes 460.

Impression data 410 may comprise log-level data, representing impressions, for historical campaigns. It should be understood that historical campaigns may include active campaigns, which have been started but have not yet been completed. Impression data 410 may be generated by a script (e.g., JavaScript) or other computer code that executes when an advertisement (e.g., image within an email message, image on a website, etc.) is viewed (e.g., downloaded to a customer's computer) or otherwise interacted with (e.g., clicked). As an example, one or more creatives (e.g., advertisements) that are generated for a campaign may comprise an embedded ad-pixel. This ad-pixel may be located at a specific Uniform Resource Locator (URL) or may cause execution of a script, such that whenever the ad-pixel is accessed, the computer code is executed. In any case, each time the computer code is executed, an event representing the impression (e.g., view, click, etc.) that triggered execution of the computer code may be stored. In this manner, the computer code generates a stream of events, representing impressions, that are stored in impression data 410. Each event may comprise information about the impression, such as the IP address (e.g., by which an ad-pixel was accessed), the type of event (e.g., view, click, etc.), the publisher (e.g., placement location) of the advertisement, a timestamp representing the time at which the event was recorded, and/or the like. It should be understood that a plurality of events could be associated with the same impression (e.g., both a view and a click of an advertisement).

Spend data 420 may comprise one or more spend parameters for historical campaigns. Each spend parameter may indicate an amount of money spent on a campaign. Each amount of money may be indicated in U.S. dollars, Euros, other currency, as an enumeration (e.g., of ranges, buckets, bins, or other quantization of monetary amounts), or in any other suitable format. The spend parameter(s) may comprise the amount of money spent for each campaign for each of one or a plurality of time intervals (e.g., one hour, twenty-four hours or one day, one week, one month, etc.). Alternatively or additionally, the spend parameter(s) may comprise the amount of money spent for each campaign as an average, mean, median, or other statistical value over a plurality of the time intervals. Alternatively or additionally, the spend parameter(s) may comprise the total amount of money spent on each campaign. In any case, the amount of money spent may include expenditures for generating advertisement(s), placing advertisement(s) in channel(s) trafficked by company accounts in the segment targeted by the campaign, sending advertisement(s) to the company accounts in the segment targeted by the campaign, paying for search engine marketing (SEM) (e.g., purchasing search terms from a search engine), and/or the like.

Segment IP addresses 430 comprise a count of targetable IP addresses for each segment. These counts may be periodically pre-calculated. The count of targetable IP addresses for a given segment may be used as a segment attribute for that segment, as discussed elsewhere herein.

Account-level impression data 440 may be derived from impression data 410. In particular, impression data 410 may be mapped to company accounts, for example, based on IP addresses, domains, cookies, and/or the like. In other words, the impressions in impression data 410 are associated with specific company accounts. Exemplary embodiments for mapping activity, including impressions, to company accounts are described, for instance, in U.S. Pat. No. 10,536,427, issued on Jan. 14, 2020, which is hereby incorporated herein by reference as if set forth in full. For each organizational account, one or a plurality of extract, transform, and load (ETL) processes may execute, periodically or in real time, to collect, transform, and aggregate impression data 410 to a granularity, from highest level to lowest level, of campaign, impression, event, company account, and date, within account-level impression data 440 (e.g., stored in database 114).

Aggregate campaign data 450 may be derived, for example, by merging spend data 420, segment IP addresses 410, and/or account-level impression data 440. In order to maintain the efficiency of the data pipeline, segment attributes may be pre-calculated and stored as aggregate campaign data 450 (e.g., in database 114). For instance, an ETL process may transform and aggregate account-level impression data 440 with spend data 420, to a granularity, from highest level to lowest level, of campaign and company account. Thus, aggregate campaign data 450 may comprise, for each of a plurality of company accounts in each of a plurality of campaigns, information about the impressions (e.g., from account-level impression data 440) and spend (e.g., from spend data 420) for that company account.

Campaigns-level segment attributes 460 may be derived from aggregate campaign data 450. Campaign-level segment attributes 460 represent a final staging table that may be used as a training dataset to train AI model 116. Campaign-level segment attributes 460 may comprise pre-calculated segment attribute(s) of the historical segment associated with each and every historical campaign. One or more, including potentially all, of these segment attribute(s) may be calculated from the impression and spend information for the company accounts in the historical segment for each campaign, as stored in aggregate campaign data 450. It should be understood that campaign-level segment attributes 460 may comprise the segment attribute(s) for each of hundreds, thousands, millions, or more historical campaigns. The data pipeline runs, periodically (e.g., hourly, daily, weekly, etc.) or in real time (as data are received, accounting for ordinary latencies in processing, communications, memory access, etc.), to continually refresh campaign-level segment attributes 460, for example, by recalculating the segment attribute(s) of the historical segment associated with each historical campaign for which new data are received. In an embodiment, the data pipeline runs periodically (e.g., at the start or end of each twenty-four hour period), instead of in real time, since the data may be so voluminous that real-time updates may degrade (e.g., slow down or interrupt) the user experience.

### 5. Example Segment Attributes

Specific examples of segment attributes, which may be provided as inputs to and used to train AI model 116, will now be described. While all of the disclosed segment attributes could be used in an embodiment, it is not a necessity to use all of the disclosed segment attributes. Rather, any subset of the disclosed segment attributes could be used. Alternatively, the segment attributes may include entirely different segment attributes than any of the segment attributes specifically disclosed herein, or may include a combination of some of the segment attributes specifically disclosed herein with other segment attributes that are not specifically disclosed herein. In general, a segment attribute may be any quantifiable property of a segment. However, it should be understood that the specific segment attributes described below have been found, by the inventors, to produce high quality matches between target segments and historical segments. In particular, the disclosed segment attributes are relevant and sensitive to the goals of the campaigns and accurately represent the targets of the campaigns.

The segment attribute(s) may comprise the size of the segment. The segment size may be the number of company accounts or other entities in the segment.

The segment attribute(s) may comprise a proportion (e.g., percentage) of the representation of each of one or more regions (e.g., geographic regions) in the segment. For example, the segment attributes may comprise a percentage of company accounts in the segment that are located (e.g., headquartered or otherwise have an office) in the United States or Canada, a percentage of company accounts in the segment that are located in the United Kingdom, a percentage of company accounts in the segment that are located in the European Union (e.g., Austria, Italy, Belgium, Latvia, Bulgaria, Lithuania, Croatia, Luxembourg, Cyprus, Malta, Netherlands, Denmark, Poland, Estonia, Portugal, Finland, Romania, France, Slovakia, Germany, Slovenia, Greece, Spain, Hungary, Sweden, Ireland, and Czechia), a percentage of company accounts in the segment that are located in the Asian-Pacific (APAC) (e.g., India, Indonesia, Pakistan, Bangladesh, Japan, Philippines, Vietnam, Thailand, Myanmar, south Korea, Malaysia, Nepal, Australia, Taiwan, Sri Lanka, Cambodia, Papua New Guinea, Laos, Singapore, New Zealand, Mongolia, Fiji, Maldives, and Brunei), and/or the like. The regions into which segments are divided may be determined according to any one or more clustering criteria, such as geographic vicinity, similarity in culture, similarity in privacy or other laws, and/or the like.

The segment attribute(s) may comprise a measure (e.g., median or mean) of the count of targetable IP addresses for the company accounts in the segment. A targetable IP address for a company account is an IP address that has been mapped to the company account in account-level impression data 440. The median of the count is the median number of targetable IP addresses associated with the company accounts in the segment, and the mean of the count is the mean number of targetable IP addresses associated with the company accounts in the segment.

The segment attribute(s) may comprise a measure (e.g., median or mean) of the spend per time interval (e.g., twenty-four hours or a day) for the company accounts in the segment. The measure of the spend per time interval for the company accounts in the segment may be calculated from historical data for the company accounts in the segment. The median spend per time interval is the median of the amount of money spent per time interval on campaigns for the company accounts in the segment, and the mean spend per time interval is the mean of the amount of money spent per time interval on campaigns for the company accounts in the segment.

The segment attribute(s) may comprise a measure (e.g., median or mean) of the reachability of the company accounts in the segment. Reachability of a company account may be defined as the ratio of the number of campaigns in which that company account was reached (e.g., at least one impression was mapped to the company account) to the number of campaigns associated with a segment that included that company account. The median reachability is the median of this ratio across all company accounts in the segment, and the mean reachability is the mean of this ratio across all company accounts in the segment.

The segment attribute(s) may comprise a minimum total spend for the company accounts in the segment and/or a maximum total spend for the company accounts in the segment. The total spend for a company account may be the total amount of money spent for that company account in campaigns. The minimum total spend is the minimum amount of money spent for a company account, across all company accounts in the segment. Similarly, the maximum total spend is the maximum amount of money spent for a company account, across all company accounts in the segment.

The segment attribute(s) may comprise persona(s) of the company accounts in the segment. Each company account may be associated with one or a plurality of personas. A persona is a set of one or more attributes representing a contact (e.g., a contactable person or job position) associated with a company account. The attribute(s) in a persona may comprise job level, job function, job responsibility, and/or the like. These attributes may be determined using a model, as described, for example, in U.S. Patent Publication No. 2023/0360065, filed on May 3, 2023, and/or U.S. patent application Ser. No. 18/196,130, filed on May 11, 2023, which are both hereby incorporated herein by reference as if set forth in full. In an alternative embodiment, the segment attribute(s) may more simply comprise, as the persona, an indication of whether or not persona(s) were targeted in the segment (e.g., a value of one for persona-based targeting, and a value of zero for no persona-based targeting). The inventors have found that persona-based targeting significantly improves the performance of a campaign. However, persona-based targeting may require more spend and/or a higher cost per thousand impressions to achieve the same reach.

When defining the target segment (e.g., in subprocess 310), a user may define one or more target personas within the target segment. In this case, these target persona(s) may be incorporated into the segment attribute(s). In other words, the use of personas adds to the segment attributes that are used for AI model 116. In an embodiment, the definition of a target persona may be optional, such that a user may determine whether or not to define persona(s) when defining the target segment. Essentially, when persona(s) are defined, specific persona(s) at each company account are targeted. Conversely, when persona(s) are not defined, each company account is targeted as a whole.

### 6. Example AI Model

A specific example of AI model 116 will now be described. In this example, AI model 116 comprises or consists of a k-nearest neighbor (KNN) algorithm. The KNN algorithm was introduced in “Discriminatory Analysis Nonparametric Discrimination: Consistency Properties,” by Evelyn Fix et al., USAF School of Aviation Medicine, 1951, and expanded upon in “Nearest Neighbor Pattern Classification,” by Thomas M. Cover et al., IEEE Transactions on Information Theory, 13 (1): 21-27, 1967, doi: 10.1109/TIT.1967.1053964, which are both hereby incorporated herein by reference as if set forth in full.

However, it should be understood that AI model 116 may comprise or consist of other algorithms that can identify campaign configurations that are associated with historical segments that are similar to the target segment and/or otherwise identify the value of each of one or more campaign settings based on a target segment. Examples of other algorithms that may be used in or as AI model 116 include, without limitation, a decision tree, a random forest algorithm, a naïve Bayes algorithm, an artificial neural network (e.g., a perceptron or deep-learning neural network), a cosine distance or similarity algorithm, a k-means algorithm, a logistic regression, a gradient-boosting algorithm (e.g., the extreme Gradient Boosting (XGBoost) algorithm), an elastic net, and/or the like. More generally, AI model 116 may comprise or consist of any algorithm that can be trained or otherwise utilized for content-based recommendation.

In an embodiment, the KNN algorithm is used to determine the k-nearest historical segments, associated with historical campaigns, that are most similar to the target segment, received in subprocess 310, in terms of their respective segment attributes. Empirically, campaigns that are tied to segments with similar segment attributes tend to perform in a similar manner. Thus, at a high level, the KNN algorithm outputs historical campaign(s) that were associated with one or more (e.g., k) historical segments having the most similar segment attributes as the target segment. The value of k may be any integer value, such as one, two, three, four, five, ten, fifteen, twenty, or the like. In a particular implementation, k was set to three.

The distance or similarity between the target segment and each historical segment may be determined based on a similarity metric for each segment attribute. The similarity metric may be calculated in any suitable manner, including, for example, as a Euclidean distance (e.g., the absolute difference between the values of a segment attribute for the target segment and the corresponding segment attribute for the historical segment). However, in an embodiment, to normalize the distances across different segment attributes, which may have different units of measure, the similarity metric for a given segment attribute i is calculated as:

$${similarity}_{i} = \frac{minimum ( {target}_{i} , {historical}_{i} )}{maximum ( {target}_{i} , {historical}_{i} )}$$

wherein similarity; is the similarity metric for segment attribute i, minimum(⋅) returns the minimum value within the parentheses, maximum(⋅) returns the maximum value within the parentheses, targetᵢ is the value of segment attribute i for the target segment, and historicalᵢ is the value of segment attribute i for the historical segment. It should be understood that the similarity metric may be calculated for each segment attribute that is being used by AI model 116. The similarity metric may be calculated for all of the segment attributes in the same manner (e.g., as similarity;), or the similarity metric for one or more of the segment attributes may be calculated in a different manner than the similarity metric for one or more other segment attributes.

In an embodiment, the segment attributes comprise the segment size (SIZE), the proportion of company accounts located in the United States or Canada (REG_USCAN), the proportion of company accounts located in the United Kingdom (REG_UK), the proportion of company accounts located in the European Union (REG_EU), the proportion of company accounts in the Asian-Pacific (REG_APAC), the count of targetable IP addresses (IP_COUNT), the median daily spend (MED_SPEND), the median reachability (MED_REACH), the minimum total spend for the company accounts (MIN_SPEND), the maximum total spend for the company accounts (MAX_SPEND), and optionally whether or not the segment includes persona-based targeting (PERSONA). An example of a similarity matrix, comprising the values of the similarity metric similarity for a subset of the above segment attributes between a target segment (i.e., associated with a historical campaign being used for testing) and each of three example historical segments A, B, and C (e.g., k=3), are depicted in Table 1 below:

TABLE 1

| | Segment | | |
|---|---|---|---|
| Segment Attribute | A | B | C |
| SIZE | 0.9 | 0.67 | 0.89 |
| REG_USCAN | 0.85 | 0.75 | 0.95 |
| REG_UK | 1 | 1 | 1 |
| REG_EU | 1 | 1 | 1 |
| REG_APAC | 1 | 1 | 1 |
| IP_COUNT | 0.87 | 0.35 | 0.88 |
| MED_SPEND | 0.56 | 0.82 | 0.92 |
| MED_REACH | 0.97 | 0.93 | 0.99 |
| PERSONA | 1 | 1 | 1 |

In an embodiment, in order to reduce the complexity of AI model 116, the value of the similarity metric for each of one or more segment attributes may be quantized. For example, the value of the similarity metric for one or more, including potentially all, of the segment attributes may be binarized into a binary value of either one or zero, based on a threshold for each segment attribute. In particular, if the value of the similarity metric for a segment attribute satisfies (e.g., is greater than or equal to) the respective threshold for that segment attribute, the value of the similarity metric may be binarized into a first value (e.g., one). Conversely, if the value of the similarity metric for a segment attribute does not satisfy (e.g., is less than) the threshold for that segment attribute, the value of the similarity metric may be binarized into a second value (e.g., zero). It should be understood that other quantizations, besides binarization, may be used. For example, the values of the similarity metric may be quantized into three, four, five, or more bins or buckets. In addition, all or only a portion of the segment attributes may quantized, according to the same or different quantizations, and all of the segment attributes that are quantized may be quantized according to the same threshold or different thresholds. Table 2 below depicts a binary similarity matrix, in which the values of the segment attributes in Table 1 have been binarized using a threshold of 0.8 for all segment attributes:

TABLE 2

| | Segment | | |
|---|---|---|---|
| Segment Attribute | A | B | C |
| SIZE | 1 | 0 | 1 |
| REG_USCAN | 1 | 0 | 1 |
| REG_UK1 | 1 | 1 | 1 |
| REG_EU | 1 | 1 | 1 |
| REG_APAC | 1 | 1 | 1 |
| IP_COUNT | 1 | 0 | 1 |
| MED_SPEND | 0 | 1 | 1 |
| MED_REACH | 1 | 1 | 1 |
| PERSONA | 1 | 1 | 1 |

In an embodiment, AI model 116 determines that a historical segment is a match to the target segment, when the binarized values of the similarity metric for all of the segment attributes are equal to the first value (e.g., one). In the above example, only Segment C would be determined to be a match. Segments A and B would not be determined to be matches, since they both contain the second value as the binarized value of the similarity metric for at least one segment attribute. The configuration of the historical campaign associated with each historical segment that is matched to the target segment (e.g., only the historical campaign associated with Segment C in the above example) may be output by AI model 115, in subprocess 330, as a candidate for a recommended campaign configuration. All others of the k historical segments (e.g., Segments A and B in the above example) may be excluded as unmatched. A small change in the values of the segment attributes can significantly change the performance of a campaign. Thus, the quantization (e.g., binarization), described above, ensures balanced and strict matching of the k historical segments, produced by the KNN algorithm, to the target segment.

In an embodiment, when the target segment is defined to include a persona, as discussed elsewhere herein, AI model 116 may be applied to the segment attributes including the persona, as well as to the segment attributes excluding the persona. AI model 116 may be applied to the segment attributes, with and without the persona, in parallel or serially. In this embodiment, AI model 116 may produce two outputs: a first set of zero, one, or a plurality of historical campaigns whose segment attributes, including the persona-based targeting, matched those of the target segment (e.g., after binarization or other quantization); and a second set of zero, one, or a plurality of historical campaigns whose segment attributes, excluding the persona-based targeting, matched those of the target segment (e.g., after binarization or other quantization). The user can select from the dual outputs based on whether or not the user is opting for persona-based targeting. In an alternative embodiment, whenever the target segment is defined to include a persona, AI model 116 is applied only to the segment attributes including the persona-based targeting, without being applied to the segment attributes excluding the persona-based targeting.

### 7. Example Thresholding Criteria

The output of subprocess 330 will represent campaign(s) that are associated with the historical segments that most closely match the target segment. However, the fact that a historical segment closely matches the target segment does not necessarily mean that the associated campaign will perform well with the target segment. Thus, the campaign(s) that are outputted by subprocess 330 represent a shortlist of campaign(s), which are candidate(s) to be recommended. In an embodiment, this shortlist of campaign(s) is passed through a performance filter comprising one or more thresholding criteria (e.g., in subprocess 340), to ensure that only well-performing campaign(s) are used in the recommendation to a user.

A specific example of the thresholding criteria, which may be used in subprocess 340, will now be described. However, it should be understood that fewer, more, or different thresholding criteria may be used. In addition, the thresholding criteria may consist of a single criterion or any plurality (e.g., two, three, four, five, etc.) of criteria.

In an embodiment, the thresholding criteria comprise or consist of a recommendation score. The recommendation score for a historical campaign may be calculated as a function of one or more other performance metrics of the historical campaign. The recommendation score and other performance metrics for each historical campaign may be pre-calculated and stored in campaigns and segment attributes 460, so that these performance metrics do not need to be calculated each time process 300 is executed.

As a specific example, the recommendation score may be calculated as:

$$recommendation score = reach \times pace$$

$$reach = \frac{reached number of company accounts in segment}{total number of company accounts in segment}$$

$$pace = \frac{\frac{actual spend per time interval}{number of time intervals passed}}{maximum spend per time interval}$$

wherein reached number of company accounts in segment is the total number of company accounts in the segment of the historical campaign that were reached (e.g., at least one impression was mapped to the company account), total number of company accounts in segment is the total number of company accounts in the segment of the historical campaign, actual spend per time interval is a measure (e.g., median or mean) of an amount of money that was actually spent per time interval (e.g., every twenty-four hours or daily) on the segment associated with the historical campaign during the historical campaign, number of time intervals passed is the number of the time intervals spanned by the historical campaign (i.e., from the time the historical campaign was initiated to the time that the historical campaign was ended or to the current time if the historical campaign is still active or ongoing), and maximum spend per time interval is the maximum amount of money spent or spendable on the segment associated with the historical campaign in a single time interval across all of the time intervals spanned by the historical campaign. The maximum spend per time interval may be a predefined amount that is set as a limit for the historical campaign, in which case no single time interval may have actually reached the value of maximum spend per time interval. For instance, if the time interval is a twenty-four hour period, the actual spend per time interval would be a measure (e.g., median or mean) amount of money spent daily on the segment across all of the days spanned by the historical campaign, number of time intervals passed would be the number of days spanned by the historical campaign, and maximum spend per time interval would be the maximum amount of money spent or spendable on the segment in a single day during the historical campaign.

In an embodiment, the thresholding criteria comprise or consist of a predefined score threshold for the value of the recommendation score. In this case, a historical campaign will not satisfy the thresholding criteria and will not be recommended in subprocess 350 unless the recommendation score satisfies (e.g., is greater than or equal to) the predefined score threshold. In other words, when the recommendation score for a historical campaign does not satisfy (e.g., is less than) the predefined score threshold, the historical campaign will not be provided in subprocess 350.

The value of reach represents the proportion (e.g., percentage) of company accounts in the segment that were reached (e.g., at least one impression was mapped to the company account). In an embodiment, the thresholding criteria comprise or consist of a predefined reach threshold for the value of reach. In this case, a historical campaign will not satisfy the thresholding criteria and will not be recommended in subprocess 350 unless the reach satisfies (e.g., is greater than or equal to) the predefined reach threshold. In other words, when the reach for a historical campaign does not satisfy (e.g., is less than) the predefined reach threshold, the historical campaign will not be provided in subprocess 350. As an example, the predefined reach threshold may be equal to 0.6.

The value of pace represents the spend rate (e.g., proportion, such as percentage, of the total budget that was or has been spent during the campaign). In an embodiment, the thresholding criteria comprise or consist of a predefined pace threshold for the value of pace. In this case, a historical campaign will not satisfy the thresholding criteria and will not be recommended in subprocess 350 unless the pace satisfies (e.g., is greater than or equal to) the predefined pace threshold. In other words, when the pace for a historical campaign does not satisfy (e.g., is less than) the predefined pace threshold, the historical campaign will not be provided in subprocess 350. As an example, the predefined pace threshold may be equal to 0.6. The predefined pace threshold may be the same as or different from the predefined reach threshold.

In an embodiment, the thresholding criteria comprise all three of the predefined score, reach, and pace thresholds. In this case, the reach, pace, and recommendation score for a historical campaign must all satisfy their respective predefined reach, pace, and score thresholds in order for the historical campaign to satisfy the thresholding criteria. In an alternative embodiment, the thresholding criteria may only comprise the predefined score threshold, in which case only the recommendation score for a historical campaign must satisfy the predefined score threshold in order for the historical campaign to satisfy the thresholding criteria. In an alternative embodiment, the thresholding criteria may only comprise the predefined reach and pace thresholds, in which case only the reach and pace must satisfy the predefined reach and pace thresholds, respectively, in order for the historical campaign to satisfy the thresholding criteria.

In any case, the historical campaign(s) that are provided in subprocess 350 may be ranked according to their respective recommendation scores (e.g., with historical campaigns having higher recommendation scores ranked higher than historical campaigns having lower recommendation scores). Historical campaigns with the same recommendation score may be ranked, relative to each other, according to their respective values of either reach or pace, or according to one or more other criteria.

### 8. Example Test Cases

Some example test cases will now be described to illustrate how process 300 may recommend campaign configurations based on high-performing historical campaigns that are closely matched to a given target segment. It should be understood that these are simply examples using one particular implementation, and that other implementations (e.g., using different segment attributes, recommending different campaign settings, etc.) are possible.

The table below illustrates segment attributes, campaign settings, and performance metrics for a test segment, which was targeted by a user-specified campaign:

Test Segment

| Segment Attribute/Campaign Setting/ | |
|---|---|
| Performance Metric | Value |
| daily spend | $16.0 |
| cost per thousand impressions (CPM) | $12.0 |
| frequency cap (maximum daily impressions per | 6 |
| company account) | |
| persona | 1 |
| segment size | 430 |
| proportion in United States and Canada | 0.0 |
| proportion in United Kingdom | 0.965 |
| proportion in European Union | 0.0349 |
| proportion in Asian-Pacific | 0.0 |
| daily spend in 50th percentile | 0.0282 |
| reach probability in 50th percentile | 0.6653 |
| reach | 0.7535 |
| actual daily spend | 0.9953 |

For this test case, an implementation of process 300 recommended the following campaign settings (e.g., expressed as ranges), shown with expected performance metrics, based on historical campaigns that performed well for similar segments to the test segment:

Recommended Campaign Configuration

| Campaign Setting/Expected Performance | Value |
|---|---|
| daily spend | $25.00-$70.00 |
| CPM | $9.00-$12.00 |
| frequency cap | 6-10 |
| expected reach | 73.01%-93.53% |
| expected actual daily spend as percentage | 66.94%-136.18% |
| of daily spend | |

In the above case, the high-performing historical campaigns associated with closely matched segments have a daily spend of 50% to 300% of the daily spend for the test segment. This indicates an opportunity to increase spending without compromising the user-specified campaign's performance. In addition, the user may decrease the cost per thousand impressions to $9-$12 to obtain more impressions. The recommended campaign configuration demonstrates a 20% increase in reach performance compared to the user-specified campaign configuration.

The table below illustrates segment attributes, campaign settings, and performance metrics for a test segment, which was targeted by a user-specified campaign that performed well on reach and spend efficiency (i.e., greater than 80%):

Test Segment

| Segment Attribute/Campaign Setting/ | |
|---|---|
| Performance Metric | Value |
| daily spend | $15.0 |
| cost per thousand impressions (CPM) | $10.0 |
| frequency cap (maximum daily impressions | 6 |
| per company account) | |
| persona | 1 |
| segment size | 1148 |
| proportion in United States and Canada | 0.8545 |
| proportion in United Kingdom | 0.0592 |
| proportion in European Union | 0.0400 |
| proportion in Asian-Pacific | 0.0226 |
| daily spend in 50th percentile | 0.0238 |
| reach probability in 50th percentile | 0.7011 |
| reach | 0.8110 |
| actual daily spend | 1.3058 |

For this test case, an implementation of process 300 recommended the following campaign settings (e.g., expressed as ranges), shown with expected performance metrics, based on historical campaigns that performed well for similar segments to the test segment:

Recommended Campaign Configuration

| Campaign Setting/Expected Performance | Value |
|---|---|
| daily spend | $15.00-$20.00 |
| CPM | $9.00-$12.00 |
| frequency cap | 6-6 |
| expected reach | 74.6%-82.4% |
| expected actual daily spend as percentage | 87.41%-132.65% |
| of daily spend | |

In the above case, the high-performing historical campaigns for closely matched segments had similar campaign settings to the user-specified campaign. Not surprisingly, similar performance is predicted for the recommended campaign configuration as were achieved with the user-specified campaign configuration.

The table below illustrates segment attributes, campaign settings, and performance metrics for a test segment, which was targeted by a user-specified campaign:

Test Segment

| Segment Attribute/Campaign Setting/ | |
|---|---|
| Performance Metric | Value |
| daily spend | $10.0 |
| cost per thousand impressions (CPM) | $3.0 |
| frequency cap | 2 |
| segment size | 24 |
| proportion in United States and Canada | 0.0 |
| proportion in United Kingdom | 0.0 |
| proportion in European Union | 1.0 |
| proportion in Asian-Pacific | 0.0 |
| median daily spend | 0.0800 |
| median reach | 0.4982 |
| actual reach | 0.9583 |
| pace | 0.6612 |

For this test case, an implementation of process 300 identified the following high-performing historical campaign for a similar segment to the test segment, shown with performance metrics:

Recommended Campaign Configuration

| Campaign Setting/Performance Metric | Value |
|---|---|
| daily spend | $8.00 |
| CPM | $5.00 |
| frequency cap | 5 |
| segment size | 27 |
| proportion in United States and Canada | 0.0 |
| proportion in United Kingdom | 0.0 |
| proportion in European Union | 1.0 |
| proportion in Asian-Pacific | 0.0 |
| median daily spend | 0.1095 |
| median reach | 0.4 |
| daily impressions | 1305.0388 |
| reach | 1.0 |
| pace | 1.0 |
| recommendation score | 1.0 |

In the above case, the recommended campaign configuration has a 40% higher pace of spending, as compared to the user-specified campaign configuration.

The table below illustrates segment attributes, campaign settings, and performance metrics for a test segment, which was targeted by a user-specified campaign:

Test Segment

| Segment Attribute/Campaign Setting/Performance Metric | Value |
|---|---|
| daily spend | $100.0 |
| cost per thousand impressions (CPM) | $100.0 |
| frequency cap | 3 |
| segment size | 321 |
| proportion in United States and Canada | 1.0 |
| proportion in United Kingdom | 0.0 |
| proportion in European Union | 0.0 |
| proportion in Asian-Pacific | 0.0 |
| median daily spend | 0.0310 |
| median reach | 0.6857 |
| actual reach | 0.9065 |
| pace | 0.5712 |

For this test case, an implementation of process 300 identified the following high-performing historical campaign for a similar segment to the test segment, shown with performance metrics:

Recommended Campaign Configuration

| Campaign Setting/Performance Metric | Value |
|---|---|
| daily spend | $100.00 |
| CPM | $15.00 |
| frequency cap | 10 |
| segment size | 307 |
| proportion in United States and Canada | 1.0 |
| proportion in United Kingdom | 0.0 |
| proportion in European Union | 0.0 |
| proportion in Asian-Pacific | 0.0 |
| median daily spend | 0.0325 |
| median reach | 0.7472 |
| daily impressions | 4448.5833 |
| reach | 0.9153 |
| pace | 1.0 |
| recommendation score | 1.0 |

In the above case, the recommended campaign configuration shows that lowering the cost per thousand impressions to $15 and increasing the frequency cap by three times could boost the pace with the same daily spend.

### 9. Model Monitoring and Feedback

FIG. 5 illustrates an example data pipeline for providing feedback to AI model 116, according to an embodiment. In particular, the data pipeline tracks campaign performance in campaign performance history 510 and recommendations in recommendation history 520, and, in process 530, evaluates the recommendations, according to the associated campaign performance, to generate or update a recommendation filter 540. Campaign performance history 510 and/or recommendation history 520 may be stored and managed within database 114.

Campaign performance history 510 may store, for each campaign that is initiated (e.g., via server application 112 of platform 110 and/or on an external system 140), one or more performance metrics. In particular, server application 112 may track the one or more performance metrics for each campaign from start to completion, and store these performance metric(s) in association with the respective campaign in campaign performance history 510. Thus, for example, campaign performance history 510 may comprise a plurality of records, in which each record comprises an identifier of a campaign and the values of one or more performance metrics for that campaign.

Recommendation history 520 may store, for each recommendation of a campaign configuration that is accepted, an identification of the campaign that implemented that accepted and recommended campaign configuration. Additionally, recommendation history 520 could also store, for each recommendation of a campaign configuration that is declined, an identification of the alternative campaign that was implemented instead. Recommendation history 520 may comprise a plurality of records, in which each record comprises an identifier of the implemented campaign, the campaign settings that were recommended for the implemented campaign, one or more expected performance metric(s) for the recommended campaign configuration, an indication of whether the recommendation was accepted or declined, and/or the like.

Process 530 evaluates the recommended campaign configurations in recommendation history 520 against the performance metric(s) of the implemented campaigns associated with those recommended campaign configurations, in campaign performance history 510, to generate a recommendation filter 540. In particular, for each implemented campaign, process 530 may determine whether or not the implemented campaign performed well according to the performance metric(s). The performance metric(s) may be compared to fixed threshold(s) and/or to the expected performance metric(s) output by subprocess 330 for the recommended campaign configuration. A performance metric which satisfies (e.g., is greater than or equal to) a fixed threshold and/or which is within a range of the expected performance metric(s) may be determined to represent high performance, whereas a performance metric which does not satisfy (e.g., is less than) the fixed threshold and/or is below and outside the range of the expected performance metric(s) may be determined to represent low performance. A campaign may be determined to be high performing when at least one performance metric represents high performance, only when all performance metrics represent high performance, or when a composite performance metric (e.g., combining two or more other performance metric(s), according to respective weightings or without weightings) indicates high performance (e.g., satisfies a fixed threshold or is within a range of expected performance). The recommendation score is one example of a composite metric that is determined as a function of reach and pace. In an embodiment, a campaign is determined to be high performing when each performance metric or one or more of the performance metrics (e.g., the recommendation score) are greater than or equal to a threshold percentage (e.g., 80%) of the expected performance metric(s).

In an embodiment, the performance metric(s), including the expected performance metric(s) if utilized, include the reach and/or pace of the campaign, as described elsewhere herein. Alternatively or additionally, the performance metric(s) may include the recommendation score for the campaign, as calculated as function of reach and pace of the campaign. However, it should be understood that alternative embodiments may utilize different performance metrics. In any case, the performance metric(s) may be calculated periodically (e.g., daily) and stored in campaign performance history 510. Similarly, process 530 may be executed periodically (e.g., daily) to update recommendation filter 540.

Recommendation filter 540 may comprise a set of under-performing campaigns, as determined by executions of process 530. In particular, each campaign that was recommended and accepted, but which, in actuality, performed poorly (e.g., less than threshold percentage of the expected performance metric(s)), as determined by process 530, can be added to recommendation filter 540. Recommendation filter 540 may be applied in subprocess 340 to prevent campaigns that are identified in recommendation filter 540 from being provided in subprocess 350. In other words, any campaigns that are included in recommendation filter 540 are excluded from being recommended in the future. Such campaigns significantly under-performed, and therefore, will not be recommended again. This ensures that bad recommendations are not repeated.

AI model 116 may be periodically retrained using a new training dataset. In such an embodiment, recommendation filter 540 could be used when retraining AI model 116. In particular, campaigns in recommendation filter 540 may be excluded from the training dataset, negative reinforcement may be used to penalize the recommendation of campaigns in recommendation filter 540, and/or the like. Once recommendation filter 540 has been incorporated into a training dataset that is used to retrain AI model 116, recommendation filter 540 may be initialized (e.g., emptied), such that it only comprises under-performing campaigns that have been identified by process 530 since the last retraining of AI model 116.

### 10. Additional Features

Some specific additional features will now be described. It should be understood that these none of these additional features are necessary to disclosed embodiments, and that these additional features are not exhaustive of the additional features that may be incorporated into disclosed embodiments.

In an embodiment, subprocess 330 may utilize log-level data (e.g., in impression data 410) to determine one or more additional segment attributes and/or recommended campaign settings. For example, the log-level data may be used to establish inventory availability (i.e., CPM bid responses vs. CPM bids won) for matching historical segments. This inventory availability may then be used to suggest potential spend and/or potential impressions for a recommended campaign configuration. As another example, the log-level data may be used to determine the maximum number of impressions that can be served to an IP address. This maximum number of impressions may be used to extrapolate recommended campaign settings up to the maximum number of impressions. For instance, if a recommended maximum daily spend is $50, but the user wants a maximum daily spend of $100 and the number of aggregated impressions is within the maximum number of impressions, the expected number of impressions that is provided to the user may be doubled (i.e., in proportion to the doubling of the maximum daily spend).

In an embodiment, as a user modifies a target segment or new campaign configuration in the user interface, AI model 116 or another model may be applied to the target segment or new campaign configuration to determine the potential impact of the modification(s) on the expected performance (e.g., a change in the expected number of daily impressions). In some cases, the model may accept a dynamic set of input features (e.g., segment attributes), such that not all input features are necessary for operation of the output. Thus, the recommended campaign configurations and/or expected performance of a campaign configuration may be updated, in real time, in the background, as each item of information corresponding to a new input feature is acquired.

In an embodiment, the segment attribute(s) may include a format of the creative(s) that are used in the segment. In other words, the target segment may be matched to historical segments, by Al model 116, based on the formats of the creatives used for the campaigns associated with the segments. This may improve the predictions that are output by AI model 116. For example, HTML5 advertisements may provide lower pace than banner advertisements, or mobile banner advertisements may provide lower pace because of lower availability.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
receive a target segment;
determine one or more segment attributes of the target segment;
apply an artificial intelligence (AI) model to the one or more segment attributes to output one or more matching segments, wherein each of the one or more matching segments is associated with a historical campaign;
determine one or more campaign configurations based on the one or more historical campaigns that are associated with the one or more matching segments;
apply one or more thresholding criteria to the one or more campaign configurations to determine one or more recommended campaign configurations from the one or more campaign configurations;
provide the one or more recommended campaign configurations to a user;
when receiving an acceptance of one of the one or more recommended campaign configurations from the user, generate a user interface for defining a new campaign configuration such that one or more fields for campaign settings are auto-populated according to the accepted recommended campaign configuration;
when receiving a declination of all of the one or more recommended campaign configurations from the user, generate the user interface for defining the new campaign configuration such that the one or more fields for campaign settings are not auto-populated according to any of the one or more recommended campaign configurations;
provide the user interface to the user; and
receive the new campaign configuration via the user interface.

2. The method of claim 1, wherein the target segment comprises a plurality of company accounts that are associated with a user account of the user.

3. The method of claim 1, wherein the one or more segment attributes are a plurality of segment attributes.

4. The method of claim 1, further comprising using the at least one hardware processor to initiate a new campaign to the target segment according to the new campaign configuration.

5. The method of claim 4, wherein initiating the new campaign comprises generating or selecting an advertisement that includes an embedded ad-pixel.

6. The method of claim 5, wherein initiating the new campaign comprises using the advertisement in at least one online channel.

7. The method of claim 1, wherein the one or more segment attributes of the target segment comprise one or more of:
a size of the target segment;
for each of one or more geographic regions, a proportion of the target segment that is located in the geographic region;
a measure of a count of targetable Internet Protocol (IP) addresses associated with the target segment;
a measure of spend per time interval for the target segment;
a measure of reachability for the target segment;
a minimum total spend for the target segment;
a maximum total spend for the target segment; or
a persona in the target segment.

8. The method of claim 1, wherein the AI model is trained using a training dataset that comprises, for each of a plurality of historical campaigns, the one or more segment attributes of a historical segment associated with that historical campaign.

9. The method of claim 8, wherein the training dataset is generated by:
acquiring impression data comprising a plurality of impressions for each of the plurality of historical campaigns;
generating account-level impression data by mapping the plurality of impressions to company accounts;
acquiring spend data comprising one or more spend parameters for each of the plurality of historical campaigns;
generating aggregate campaign data by merging the account-level impression data and the spend data; and
for each of the plurality of historical campaigns, calculating segment attributes of a historical segment, associated with the historical campaign, from the aggregate campaign data.

10. The method of claim 1, wherein the AI model comprises a k-nearest neighbor (KNN) algorithm that is trained to determine, from a plurality of historical segments, k historical segments that are nearest the target segment, based on a similarity between the target segment and the k historical segments in terms of the one or more segment attributes.

11. The method of claim 10, wherein determining one or more matching segments comprises calculating a similarity metric for each of the one or more segment attributes.

12. The method of claim 11, wherein the similarity metric, for each segment attribute i in the one or more segment attributes, is calculated, between the target segment and each respective one of the k historical segments, as:
$${similarity}_{i} = \frac{minimum ( {target}_{i} , {historical}_{i} )}{maximum ( {target}_{i} , {historical}_{i} )}$$
wherein minimum(⋅) returns a minimum value, maximum(⋅) returns a maximum value, targetᵢ is a value of the segment attribute i for the target segment, and historicalᵢ is a value of the segment attribute i for the respective one of the k historical segments.

13. The method of claim 11, wherein determining one or more matching segments further comprises:
for each of the one or more segment attributes, quantizing the similarity metric that was calculated for the segment attribute into either a first value or a second value, wherein the first value indicates that the similarity metric satisfies a respective threshold, and wherein the second value indicates that the similarity metric does not satisfy the respective threshold; and
for each of the k historical segments,
when all of the similarity metrics are the first value after quantization, determine that the historical segment matches the target segment, and
when at least one of the similarity metrics is the second value after quantization, determine that the historical segment does not match the target segment.

14. The method of claim 1, wherein applying the AI model to the one or more segment attributes comprises:
applying the AI model to the one or more segment attributes, with persona-based targeting, to determine a first set of one or more matching segments; and
applying the AI model to the one or more segment attributes, without persona-based targeting, to determine a second set of one or more matching segments,
wherein the one or more matching segments that are output by the AI model are a plurality of matching segments that include the first set and the second set.

15. The method of claim 1, wherein applying one or more thresholding criteria to the one or more campaign configurations comprises, for each of the one or more campaign configurations:
determining one or more performance metrics of the campaign configuration;
determining whether or not the campaign configuration satisfies the one or more thresholding criteria based on the one or more performance metrics;
when determining that the campaign configuration satisfies the one or more thresholding criteria, including the campaign configuration in the one or more recommended campaign configurations; and
when determining that the campaign configuration does not satisfy the one or more thresholding criteria, exclude the campaign configuration from the one or more recommended campaign configurations.

16. The method of claim 15, wherein the one more performance metrics for each of the one or more campaign configurations comprise a reach, a pace, and a recommendation score that is calculated as a function of the reach and the pace.

17. The method of claim 16, wherein, for each of the one or more campaign configurations, the reach and the pace are calculated as:
$$reach = \frac{reached number of company accounts in segment}{total number of company accounts in segment}$$
wherein reached number of company accounts in segment is a total number of company accounts in the matching segment that is associated with the historical campaign on which the campaign configuration is based, total number of company accounts in segment is a total number of company accounts in the matching segment that is associated with the historical campaign on which the campaign configuration is based, actual spend per time interval is a measure of an amount of money that was actually spent per a time interval on the matching segment that is associated with the historical campaign on which the campaign configuration is based, number of time intervals passed is a number of the time intervals spanned by the historical campaign on which the campaign configuration is based, and maximum spend per time interval is a maximum amount of money spent or spendable, on the matching segment that is associated with the historical campaign on which the campaign configuration is based, in a single one of the time intervals.

18. The method of claim 16, wherein determining whether or not the campaign configuration satisfies the one or more thresholding criteria based on the one or more performance metrics comprises:
determining whether or not the reach satisfies a reach threshold;
determining whether or not the pace satisfies a pace threshold; and
when either the reach does not satisfy the reach threshold or the pace does not satisfy the pace threshold, determining that the campaign configuration does not satisfy the one or more thresholding criteria.

19. A system comprising:
at least one hardware processor; and
software configured to, when executed by the at least one hardware processor, receive a target segment,
determine one or more segment attributes of the target segment,
apply an artificial intelligence (AI) model to the one or more segment attributes to output one or more matching segments, wherein each of the one or more matching segments is associated with a historical campaign,
determine one or more campaign configurations based on the one or more historical campaigns that are associated with the one or more matching segments,
apply one or more thresholding criteria to the one or more campaign configurations to determine one or more recommended campaign configurations from the one or more campaign configurations,
provide the one or more recommended campaign configurations to a user,
when receiving an acceptance of one of the one or more recommended campaign configurations from the user, generate a user interface for defining a new campaign configuration such that one or more fields for campaign settings are auto-populated according to the accepted recommended campaign configuration,
when receiving a declination of all of the one or more recommended campaign configurations from the user, generate the user interface for defining the new campaign configuration such that the one or more fields for campaign settings are not auto-populated according to any of the one or more recommended campaign configurations,
provide the user interface to the user, and
receive the new campaign configuration via the user interface.

20. A non-transitory computer-readable medium having instructions stored therein, wherein the instructions, when executed by a processor, cause the processor to:
receive a target segment;
determine one or more segment attributes of the target segment;
apply an artificial intelligence (AI) model to the one or more segment attributes to output one or more matching segments, wherein each of the one or more matching segments is associated with a historical campaign;
determine one or more campaign configurations based on the one or more historical campaigns that are associated with the one or more matching segments;
apply one or more thresholding criteria to the one or more campaign configurations to determine one or more recommended campaign configurations from the one or more campaign configurations;
provide the one or more recommended campaign configurations to a user;
when receiving an acceptance of one of the one or more recommended campaign configurations from the user, generate a user interface for defining a new campaign configuration such that one or more fields for campaign settings are auto-populated according to the accepted recommended campaign configuration;
when receiving a declination of all of the one or more recommended campaign configurations from the user, generate the user interface for defining the new campaign configuration such that the one or more fields for campaign settings are not auto-populated according to any of the one or more recommended campaign configurations;
provide the user interface to the user; and
receive the new campaign configuration via the user interface.
